(19) United States
(12) Patent Application Publication
(10) Pub. No.: US 2023/0036014 A1
(43) Pub. Date: Feb. 2, 2023

(54) SITUATION-DEPENDENT LIMITATION OF A STEERING BEHAVIOR

(71) Applicant: Robert Bosch GmbH, Stuttgart (DE)

(72) Inventors: David Schmitz, Mundelsheim (DE); Michael Foerstner, Ludwigsburg (DE)

(21) Appl. No.: 17/789,898

(22) PCT Filed: Jan. 11, 2021
(86) PCT No.: PCT/EP2021/050344

§ 371 Date: Jun. 29, 2022

(30) Foreign Application Priority Data
Jan. 17, 2020 (DE) 10 2020 200 545.1

(51) Int. Cl. B62D 15/02; B62D 6/00; G08G 1/16

(52) U.S. Cl. CPC B62D 15/025; B62D 6/002; G08G 1/167

(57) ABSTRACT

A method for the situation-dependent calculation of a limitation for a steering torque and/or for calculating a control command for a steering system of a vehicle using a control device. Data are received about a vehicle environment, a planned trajectory, and/or data from sensors of the vehicle, a driving situation of the vehicle is ascertained based on the received data, a situation-dependent limitation of a steering behavior such as a steering torque is calculated based on the ascertained driving situation, and a control command for adjusting the calculated situation-dependent limitation of the steering behavior is output. A control device, a computer program as well as a machine-readable memory medium are described.

### FIELD

The present invention relates to a method for the situation-dependent calculation of a limitation for a steering torque and/or a control command for a steering system of a vehicle. In addition, the present invention relates to a control device, a computer program and a machine-readable memory medium.

### BACKGROUND INFORMATION

Driver assistance systems which are classified as assisting or semiautomated according to the BASt standard make use of the electric power steering system for the transverse vehicle guidance. The actuator of the power steering can implement steering interventions even without any contribution of the driver and, for example, keep the vehicle inside a traffic lane in an automated manner. In these driver assistance systems, the driver continues to be responsible for the control of the vehicle and must assume the vehicle control in the event of a malfunction or an incorrect intervention of the driver assistance system.

In the development and calibration of such driver assistance systems, the steering performance and a significant automated steering intervention are in conflict with the controllability of the vehicle in the event of a system error. The greater the steering torque jumps or the steering torque gradients, the lower the controllability.

To ensure the controllability of the vehicle while the driver assistance system is activated, a limitation of the maximum steering torque and the maximum steering torque gradients is usually implemented. However, such a limitation is problematic because the steering torque for a travel of the vehicle in tight curves could possibly be insufficient on account of the reduced steering performance and the driver would have to actively support the driver assistance system. Moreover, in future driver assistance systems featuring a higher degree of automation, the limited steering performance is insufficient to allow for hands-free driving.

### SUMMARY

An object on which the present invention is based may be seen in providing a method for the situation-dependent adaptation of the control commands for the steering system.

This object may be achieved by the present invention. Advantageous embodiments of the present invention are disclosed herein.

According to one aspect of the present invention, a method for the situation-dependent calculation of a limitation for a steering torque and for the calculation of a control command for a steering system of a vehicle by a control device is provided.

In particular, a steering behavior of the vehicle is able to be adjusted by a driver assistance system in order to achieve the greatest controllability possible and, at the same time, the highest steering performance possible.

In accordance with an example embodiment of the present invention, in one step, data about a vehicle environment, a planned trajectory and/or data from sensors of the vehicle are received. A driving situation of the vehicle is ascertained based on the received data. The driving situation may be ascertained in order to estimate an expected steering behavior of the vehicle. In a driving situation ascertained as cornering, for example, a higher steering torque than in straight-ahead driving can be expected. As an alternative or in addition to the data about the vehicle environment, it is also possible to receive external or so-called offboard data, e.g., in the form of map data.

Based on the ascertained driving situation, a situation-dependent limitation of a steering behavior such as a steering torque is calculated. The calculation of the situation-dependent limitation is able to be adjusted to a behavior of the vehicle expected for the driver. In this context, the steering behavior pertains to all control commands and interventions that have an active or passive influence on the steering system of the vehicle.

In a subsequent step, a control command for adjusting the calculated situation-dependent limitation of the steering behavior is output. As an alternative, it is also possible that the control device generates and outputs a multitude of control commands in order to implement a corresponding limitation of the steering behavior of the vehicle.

The information for the limitation and/or for the detected driving situation may optionally be transmitted to the driver assistance system so that it can be considered there appropriately.

In accordance with an example embodiment of the present invention, the method is able to be realized in the form of an intelligent and situation-dependent steering torque limiter for driver assistance systems. The situational limitation of the allowed adjustable steering behavior, e.g., a steering torque, to the steering torque requirement actually to be expected in this situation enables a greater steering performance with the same or better controllability by the driver.

For example, in a driving situation classified as straight-ahead driving, only the amount of steering torque that would normally be required for maintaining the straight-ahead driving and for adjusting for interference such as ruts or cross winds may be allowed by the present method.

In addition, parking operations, slow cornering, fast cornering, straight-ahead driving on single-lane or multi-lane roads and the like may be considered as a driving situation of the vehicle.

According to a further aspect of the present invention, a control device is provided, the control device being designed to carry out the present method. For example, the control device may be a vehicle-side control device, a vehicle-external control device, or a vehicle-external server unit such as a Cloud system.

In addition, according to one aspect of the present invention a computer program is provided, which includes commands that when the computer program is executed by a computer or a control device, induce it to carry out the method according to the present invention. According to a further aspect of the present invention, a machine-readable memory medium is provided on which the computer program according to the present invention is stored.

The vehicle may be operated in an assisted manner according to the BASt standard, in a semiautomated, highly automated and/or fully automated manner or be operated without a driver.

For example, the vehicle can be developed as a passenger vehicle, a truck, a robo-taxi and the like. The vehicle is not restricted to an operation on roads. Instead, the vehicle may also be developed as a water vehicle, an airborne vehicle such as a transport drone, and the like.

According to one exemplary embodiment of the present invention, to ascertain the driving situation, data of a vehicle state, e.g., a vehicle velocity, a yaw rate, a transverse acceleration or a steering angle, a current and planned trajectory of the vehicle, a course of a traveled road, a behavior of adjacent road users, detected traffic signs and/or courses of roads ascertained from map data and future roads are received. These input variables may be utilized, individually or in any combination, for a situation detection.

According to a further embodiment of the present invention, the driving situation and the situation-dependent limitation of the steering behavior are ascertained using a vehicle model. This makes it possible to realize a model-based feedforward in a control loop by which the knowledge about the controlled system is used to improve the control quality. Physical or empirical vehicle models are able to be used for ascertaining or calculating the suitable situational limitation of the steering behavior. The vehicle models may be developed as simplified single-track models or as more complex models including a comprehensive consideration of the vehicle environment.

According to one further exemplary embodiment of the present invention, the driving situation and the situation-dependent limitation of the steering behavior are ascertained with the aid of historical, application-specific and/or statistical data. This measure makes it possible to utilize knowledge about the controlled system or an upcoming route segment in order to improve the controllability of system errors. Historical and/or statistical data may be used in the process, which are stored offline, online or are stored on a Cloud.

According to a further embodiment of the present invention, the situation-dependent limitation of the steering behavior broadens or restricts an existing limitation of a steering torque and/or a steering gradient. The actual limitation of the steering behavior of the vehicle is thereby able to be carried out in a variety of ways. For example, a situational broadening or restricting of the limitation values of an existing limiter may be realized by the present method.

According to a further exemplary embodiment of the present invention, a lower limit value and an upper limit value are calculated and adjusted for the situation-dependent limitation of the steering behavior. The limitation of the steering behavior is thus able to take place based on a situationally calculated upper and lower limit for a setpoint signal. The setpoint signal may preferably be a signal that is used by the driver assistance system for adjusting the steering movement.

This setpoint signal is able to be modified by the limitation in order to achieve an adaptation of the steering behavior. An increase or a reduction of the setpoint value may allow for a steering behavior that is adapted as a function of the situation.

According to a further embodiment of the present invention, the situation-dependent limitation of the steering behavior is adjusted in the form of a limitation of the steering torque at a steering wheel, an EPS motor and/or at at least one wheel with the aid of an output control command. The limitation is therefore able to be set directly at a steering linkage or a vehicle-side steering system. For example, actuators may be actuated for this purpose in order to bring about or damp a steering wheel movement.

According to a further exemplary embodiment of the present invention, the situation-dependent limitation of the steering behavior is calculated as a force limitation, an angle limitation and/or a position limitation, and adjusted by an output control command. A setpoint signal of a vehicle steering system to be limited may be implemented by limiting a torque at a desired level, e.g., the steering wheel, of the EPS motor or the steered wheel of the vehicle.

In addition, a maximally acting force on a gear rack, a tie rod, a steering linkage or a steered wheel is able to be influenced by the limitation of the steering behavior of the driver assistance system.

The limitation of the steering behavior can be realized by adjusting an angle at an arbitrary location of the vehicle, e.g., at a steering wheel, an EPS motor angle, or an angle of steered wheels of the vehicle.

In addition, the possible position and a freedom of movement may be restricted at an arbitrary location such as a toothed rack, by the limitation of the steering behavior.

Below, preferred exemplary embodiments of the present invention are described in greater detail based on heavily schematized representations.

### BRIEF DESCRIPTION OF EXAMPLE EMBODIMENTS

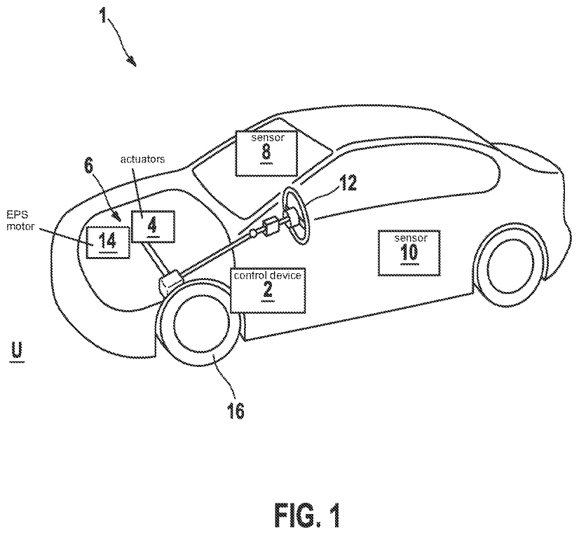

FIG. 1 shows a schematic representation of a vehicle in accordance with an example embodiment of the present invention.

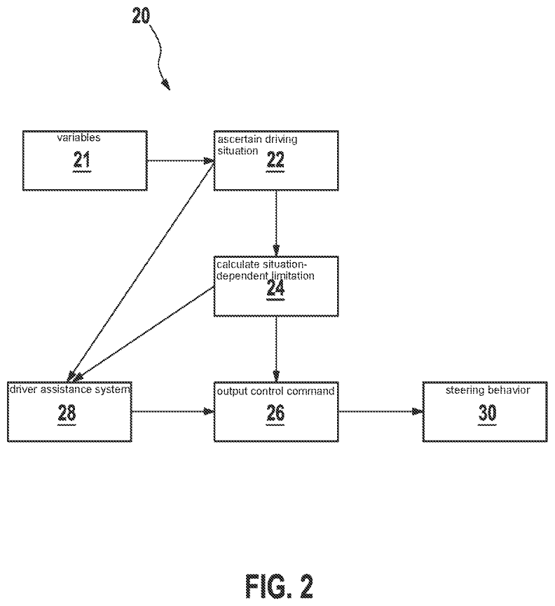

FIG. 2 shows a schematic representation of a flow diagram to illustrate a method according to one embodiment of the present invention.

### DETAILED DESCRIPTION OF EXAMPLE EMBODIMENTS

FIG. 1 shows a schematic representation of a vehicle 1. Vehicle 1 may be a vehicle 1 that is operable in an automatic or semi-automatic manner, for instance. Vehicle 1 is particularly designed to carry out at least one driver assistance function.

The driver assistance function is used for the control of a transverse vehicle guidance of vehicle 1. To this end, a control device 2 is able to actuate actuators 4 of an electric power steering system 6 with the aid of control commands.

Vehicle 1 has sensors 8, 10 for scanning environment U and for ascertaining properties of vehicle 1. Vehicle 1 may be equipped with environment sensors 8 such as LIDAR sensors, camera sensors or radar sensors for this purpose.

In addition, state sensors 10 are provided for ascertaining measuring data pertaining to a vehicle state, e.g., acceleration sensors, yaw and rate-of-rotation sensors, steering angle sensors and the like.

In addition, GNSS sensors may be used in vehicle 1 for determining a position of vehicle 1 within environment U.

Sensors 8, 10 are connected to control device 2 in a data-transmitting manner. As a result, control device 2 can receive and evaluate measuring data from sensors 8, 10. A driving situation, for instance, is able to be ascertained with the aid of the received measuring data.

To ascertain the driving situation, data of a vehicle state such as a vehicle velocity, a yaw rate, a transverse acceleration or a steering angle, a current and planned trajectory of the vehicle, a course of a traveled road, a behavior of adjacent road users, detected traffic signs and/or courses of roads ascertained from map data and future courses of roads can be received. These input variables, individually or in any combination, may be used for a situation detection of the driving situation.

Depending on the development of vehicle 1, a situation-dependent limitation of the steering behavior of vehicle 1 is able to be adjusted. This may be accomplished in an automated manner with the aid of control device 2. In particular, the situation-dependent limitation can be implemented while a driver assistance system is activated.

For example, a limitation of a steering torque may become effective at a steering wheel 12 of vehicle 1, an EPS motor 14 of electronic power steering system 6, or at a wheel 16 of vehicle 1. Control device 2, for instance, is able to actuate actuators 4 for this purpose in order to induce or damp a steering wheel movement of steering wheel 12.

In particular, EPS motor 14 is able to adjust the steering position of wheels 16 across a dynamically situation-dependent range while the driver assistance system, e.g., a lane keeping assistant, is in operation. The limitation of the steering behavior may influence or adjust the maximum steering rate and a maximum steering width or steering angle of EPS motor 14, for instance.

Control device 2 is capable of adjusting the limitation or the dynamic variation of the steering behavior of vehicle 1.

FIG. 2 shows a schematic representation of a flow diagram to illustrate a method 20 according to one embodiment. Method 20 is used to adjust a limitation of a steering behavior of vehicle 1 and is preferably able to be carried out by control device 2. Method 20 is able to be developed in the form of a limiter.

The method of functioning of method 20 will be described in the following text. The functional block representation is not meant to restrict the physical realization of the functions on individual control devices 2. As a matter of principle, it is therefore irrelevant for the present invention on which control device the limitation of the steering behavior is calculated or whether the calculation is distributed to different control devices.

In a first step 22, a driving situation of vehicle 1 is ascertained based on input variables 21. For example, parking operations, slow cornering, fast cornering, straight-ahead driving on single-lane or multi-lane roads and the like may be taken into consideration as a driving situation of vehicle 1.

In order to ascertain the driving situation, data about a vehicle environment U, a planned trajectory, and/or data from sensors 8, 10 of vehicle 1 are able to be received. A driving situation of vehicle 1 will then be ascertained based on the received data.

Depending on the number and type of input signals or data used, it can be taken into account that the situation is unable to change rapidly in a random fashion. For example, due to the driving dynamics, vehicle 1 is unable to change from straight-ahead driving to cornering within fractions of a second.

In a further step 24, a situation-dependent limitation of a steering behavior of vehicle 1 such as a steering torque and/or a steering gradient is calculated based on the ascertained driving situation. A calculation of the limitation of the steering torque that is meaningful for and adapted to this situation is performed.

The limitation of the steering behavior is not exclusively restricted to a reduction or limitation of factors that are decisive for the steering. The limitation of the steering behavior, for instance, may also include a broadening of steering angle limits.

In a subsequent step 26, at least one control command for adjusting the calculated situation-dependent limitation of steering behavior 30 is output. For example, this may be realized by a software-based and/or hardware-based limiter. The limiter is then able to adapt a signal from a driver assistance system 28 in order to carry out the control commands of control device 2.

As an alternative, the control device as a driver assistance system is able to directly generate control commands to control the steering behavior of vehicle 1 and to drive actuators 4.

In the process, control device 2 may act directly on actuator 4 for implementing the limitation. As an alternative or in addition, control device 2 is able to forward control commands to further control devices (not shown) in order to realize a limitation of the steering behavior.

As a result of method 20, in a driving situation categorized as straight-ahead driving, for example, it is possible to allow only the amount of steering torque that is usually required for maintaining the straight-ahead driving and for adjusting for interference such as ruts or cross winds. During cornering, a greater steering torque or a greater steering torque gradient is able to be allowed.

For example, a curve radius or a dynamic curve characteristic such as in the case of a road featuring many twists and turns may be utilized as a measure of the limitation of the steering behavior.

1-11. (canceled)

12. A method for a situation-dependent calculation of a limitation for a steering torque and/or for calculating a control command for a steering system of a vehicle using a control device, the method comprising the following steps:
receiving data about a vehicle environment and/or a planned trajectory and/or data from sensors of the vehicle;
ascertaining a driving situation of the vehicle based on the received data;
calculating a situation-dependent limitation of a steering behavior based on the ascertained driving situation;
outputting a control command for adjusting the calculated situation-dependent limitation of the steering behavior.

13. The method as recited in claim 12, wherein the situation-dependent limitation is a situation-dependent steering torque.

14. The method as recited in claim 12, wherein to ascertain the driving situation, data of a driving state and/or a current and planned trajectory of the vehicle, and/or a course of a traveled road and/or a behavior of adjacent road users and/or detected traffic sign, and/or a course of roads ascertained from map data and future courses of roads, are received.

15. The method as recited in claim 12, wherein the driving situation and the situation-dependent limitation of the steering behavior are ascertained using a vehicle model.

16. The method as recited in claim 12, wherein the driving situation and the situation-dependent limitation of the steering behavior are ascertained with using historical data and/or application-specific data and/or statistical data.

17. The method as recited in claim 12, wherein the situation-dependent limitation of the steering behavior causes a broadening or restriction of an existing limitation of a steering torque and/or a steering gradient.

18. The method as recited in claim 12, wherein a lower limit value and an upper limit value are calculated and adjusted for the situation-dependent limitation of the steering behavior.

19. The method as recited in claim 12, wherein the situation-dependent limitation of the steering behavior is adjusted in the form of a limitation of the steering torque at a steering wheel and/or an EPS motor and/or at at least one wheel, by an output control command.

20. The method as recited in claim 12, wherein the situation-dependent limitation of the steering behavior is calculated as a force limitation and/or an angle limitation and/or a position limitation, and adjusted by an output control command.

21. A control device for a situation-dependent calculation of a limitation for a steering torque and/or for calculating a control command for a steering system of a vehicle using a control device, the control device configured to:
receive data about a vehicle environment and/or a planned trajectory and/or data from sensors of the vehicle;
ascertain a driving situation of the vehicle based on the received data;
calculate a situation-dependent limitation of a steering behavior based on the ascertained driving situation;
output a control command for adjusting the calculated situation-dependent limitation of the steering behavior.

22. A non-transitory machine-readable memory medium on which is stored a computer program for a situation-dependent calculation of a limitation for a steering torque and/or for calculating a control command for a steering system of a vehicle using a control device, the computer program, when executed by a computer, causing the computer to perform the following steps:
receiving data about a vehicle environment and/or a planned trajectory and/or data from sensors of the vehicle;
ascertaining a driving situation of the vehicle based on the received data;
calculating a situation-dependent limitation of a steering behavior based on the ascertained driving situation;
outputting a control command for adjusting the calculated situation-dependent limitation of the steering behavior.
